(19) United States
(12) Patent Application Publication
(10) Pub. No.: US 2017/0323374 A1
(43) Pub. Date: Nov. 9, 2017

(54) AUGMENTED REALITY IMAGE ANALYSIS METHODS FOR THE VIRTUAL FASHION ITEMS WORN

(71) Applicant: Seok Hyun PARK, Busan (KR)

(72) Inventor: Seok Hyun PARK, Busan (KR)

(21) Appl. No.: 15/148,847

(22) Filed: May 6, 2016

(51) Int. Cl. G06Q 30/06; G06T 11/60; G06T 7/60; G06K 9/00; G06K 9/62; G06K 9/52; G06T 5/00; G06T 7/20

(52) U.S. Cl. CPC G06Q 30/0643; G06T 5/00; G06T 11/60; G06T 7/60; G06T 7/20; G06K 9/00255; G06K 9/6267; G06K 9/52; G06K 9/00335; G06K 9/00281; G06T 2207/20172

(57) ABSTRACT

An image analysis method for virtual wear fashion items worn on the head portion of a person such as hats, earrings, and glasses in augmented reality is provided. The image analysis method includes: Step A, receiving a user smart devices; Step B, a smart device that can shoot the head portion of the user obtain the video in real time; Step C, extracting feature information about the smart devices in the nose, mouth, forehead, ears, by the eye of the user's face from a real-time video; Step D, generating the characteristic point based on the feature information for tracking the feature points in accordance with the movement of the head part video; and Step E, synthesizing the virtual image of the product to fashion the head portions of the video of the variable so as to correspond to the movement of the feature point.

### BACKGROUND OF THE INVENTION

### Field of the Invention

The present invention is fashion so that you can see by wearing fashion products such as relates to the augmented reality image analysis methods for fashion goods virtual wear, more particularly caps on their appearance are taken with the camera, earrings, and glasses virtual goods. The present invention relates to an augmented reality image analysis method for virtual wear.

### Description of Related Art

Modern with an emphasis on individuality was common to use the Internet as a means of obtaining information to find the right for current fashion trend and fashion and selves.

Due to this trend, the Internet was born, the various shopping malls have blossomed, the most popular fashion items, including the Mall to receive one of the areas of goods and accessories.

Using the Internet to purchase fashion products you are used to purchase the desired product without the physical effort in time I want to take full advantage of the temporal and spatial freedom offered by the Internet.

If the user is interested in the image of the products identified and posted the images available on the web pages of fashion goods mall and confirm the detailed information by selecting it becomes a purchase is made through them.

The purchase method is occurs, such as when the subject image is different feeling when actually received items seemed good in case of a fashion product images are frequent and result returned, the return of the product in time to operators, producers and buyers, there is a problem that led to monetary damages.

It is designed to solve this problem there is a fashion information providing method through the Internet.

Fashion informative way across the Internet image data to create a database of user information and provide coordinated services that show to synthesize products and body, or virtual models entered by the user, etc. apparel products, namely, clothing, glasses, shoes, hat there are ways in which they provide a coordinated solution as a pre-coated with the selected products spring.

As a prior art Republic of Korea Patent Publication No. 10-2004-0090791 (2004 Oct. 27. Public), the bar is disclosed “a method and apparatus garment-UP”.

The prior art relates to a technique to coordinate the selected garment to the customer himself to the model directly, the image for the store clothes information unit for storing extracts the image of the clothes information of the electronic catalog, the customer input through the camera and model information storage unit that receives and stores the information, and outputs a variety of clothing type, and controlled so that when one is selected among various garment types outputting garment information and output the model image with the chosen garment information according to customer needs of image combination the control unit and, discloses an image combination unit, and clothing type and garment information technology made of a display unit for displaying the synthesized image that synthesizes the model information and the selected garment information output to the composite video customer image coordinate to a selected garment have.

In addition, as another prior art, Republic of Korea Patent Publication No. 10-2004-0093576 (2004 Nov. 6. Publication), “personalized clothing image display system and method,” it has disclosed bar.

As the prior art in accordance with the body size and posture to a technique for displaying After adjusting the size and angle of the parts of the garment image are synthesized with the customer of the image, taking the customer with a camera and storing in advance a plurality of garment image and after synthesis the garment image stored in the output image, discloses a technique for display on the display panel. A particular output image customer image except for the background screen, and extracts only the customer image and extracted in the division, depending on the parts of the body in accordance with the image of the body, each divided part determining the customer size and position of, and clothing selection command reads out the garment image editing according to the size and posture of the customer determines a read-out image is selected in accordance with clothing and, after the edited image to the output synthesized image on clothing discloses a technique for displaying the output.

However, with the prior art, such as to display the synthesis of the customer has already been given taking the garment video image; you can adjust the garment itself in part. That is, it is suggested in accordance with the technique only viewing of the customer recorded by selecting one of the image information clothing. In addition, a video edit the garment according to customer size and position from the taken images, simply due to being the wrong posture edit the garment image to fit it.

Moreover, coordinated services on the Internet when hit because it uses a virtual model on the cyber space not the real fact on his body that fashion products such as clothing, hats, eyeglasses own taste, physical characteristics, skin and hair color the overall harmony cannot determine exactly sure of, and therefore after purchase of the product is frequently the case that failure to return satisfied with the product.

In addition, consumers sometimes go find a department store or shopping mall offline after purchase does not determine if the fit for yourself in the field after the over garment body view coming home thanks you listen to the opinions of other people determines that belong to them also frequently the case that many return or exchange clothing.

The consumer has no choice but to fall significantly if the product satisfaction of fashion goods purchased over the Internet to try to see if we needed to return and offline consumers buy fashion items is a natural result. Shopping service for consumers available in the online issue Due to this situation is not yet bound to fall reliability and satisfaction.

### SUMMARY OF THE INVENTION

### The Problems to be Solved

An object of the present invention for solving the derived problem in the preceding background art is simply that that synthesis of fashion items on your picture image, not caps on their face images taken with the camera, earrings, fashion goods, such as glasses the virtual look worn to provide the augmented reality image analysis method for a virtual fashion items worn so that it seems to be shown in the video as if looking in a mirror.

On the other hand, not limited to the purpose of the present invention are referred to in the above-mentioned object, another object that is not mentioned will become clearly understood from the following description.

### Solving Means of the Problem

The above objects, the present invention fashion items from the embodiment in accordance with, in an augmented reality image analysis methods for virtual wear fashion items that are worn on the head portion of a person such as hats, earrings, glasses, fashion goods Mall servers in a method comprising: receiving a user smart device a virtual image; Step B is a smart device that can shoot the head portion of the user obtain the video in real time; C comprising the steps of extracting feature information about the smart devices in the nose, mouth, forehead, ears, by the eye of the user's face from a real-time video; Step D to generate the characteristic point based on the feature information for tracking the feature points in accordance with the movement of the head part video; And step E to synthesize a virtual image of the product to fashion the head portions of the video of the virtual image is variable so as to correspond to the movement of the feature point; It comprises of clothing products which can be achieved by the augmented reality image analysis method for virtual wear.

Here, the C phase, and the C-1 comprising: capturing a face image in the user's head portion, the C-2 step from the captured facial image to extract the feature information of the face, based classified type of the feature information compared with step C-3 to extract the type information of the face, and C combine the characteristics of the extracted facial information and type information to generate the polygons on the face and create the side and back images of the user's head from which characterized by including the step-4.

Incidentally, the step C2, and C-2-1 extracting mouth and eyes from the facial image face, and the step C-2-2 by connecting the extracted eyes and the mouth to the triangle shape for extracting the nose region, and the and the co-region C 2-3 steps to analyze the edges and the color change in the extract the details of the nose, and the step C-2-4 to analyze the change in the color extraction area on the extracted eye brows, C-2-5 wherein the extracting the facial feature points and a contour of the face, and C- to combine measured values and statistics for each facial area of the extracted user to extract the face feature information of the face required for the polygon generation characterized by including the step 2-6.

In addition, the present invention according to another embodiment, the cap, earrings, in the augmented reality image analysis method for virtual wear fashion items that are worn on the head portion of the person, such as glasses, a virtual image of a fashion product from the fashion items mole server a method comprising: receiving a user of smart devices; Step B is a smart device that can shoot the head portion of the user obtain the video in real time; C comprising the steps of extracting feature information about the smart devices in the nose, mouth, forehead, ears, by the eye of the user's face from a real-time video; Step D the image information of the user's head portion that is generated from the feature information extracted by re-calibrated to the preference of the user; Generating a feature point as a rough correction based on the feature information to the E step of tracking feature points in accordance with the movement of the head part video; Augmented reality image analysis for fashion items virtual wear comprising a; and wherein the virtual image to the head portion of the video synthesizing a virtual image of the fashion items F phase varying to correspond to the movement of the feature point this object can be achieved by the method.

Here, the o phase, and D-1 steps to correct mouth eyes and extracted from the facial image, to check the information on the nose by connecting the corrected eye and mouth with a reverse triangle shape is extracted again, as the information process or the D-2 step for correcting according to the preferences of the user to check the to analyze the color change in the area on the corrected eye brow information to be extracted again, D for the information as in progress, or corrected in accordance with the preference of the user and step 3, D-4 and the step of correcting the contour and feature points extracted from the face image face, D-5 correcting the skin color extracted from the face image and the face; Characterized in that by combining the actually measured value and status information for each face region the corrected containing D-6 comprising the steps of: extracting a user's facial face feature information required to generate the polygons.

### Effects of the Invention

According to the present invention according to the above embodiment, it may represent a natural on their face images taken with the camera, as shown in the mirror the appearance fashion goods virtual wear is an effect that can greatly improve the reliability and satisfaction of the consumer.

### BRIEF DESCRIPTION OF THE DRAWINGS

FIG. 1 is a block diagram showing the augmented reality image analysis method according to an embodiment of the present invention.

FIG. 2 is a block diagram showing the details of step C according to the embodiment of the present invention.

FIG. 3 is a block diagram showing the details of the step C-2 in accordance with an embodiment of the present invention.

FIG. 4 is a conceptual diagram showing the augmented reality analysis method according to an embodiment of the present invention.

FIG. 5 is a block diagram showing the augmented reality image analysis method according to another embodiment of the present invention.

### DETAILED DESCRIPTION OF THE PREFERRED EMBODIMENTS

Advantages and features and methods of accomplishing the same of the present invention by reference to the embodiments which are described in detail in conjunction with the accompanying drawings will be apparent. However, the invention will be implemented in that as a variety of different that forms limited to the embodiments set forth below, only, and the present embodiments are to the disclosure of the invention complete, one of ordinary skill in the art. It is provided to alert the party to complete the scope of the invention. And the terms used herein are for purposes of describing the embodiments, and are not intended to limit the present invention. In this specification the singular also includes the plural unless specifically stated otherwise in the text.

Hereinafter, with reference to the accompanying drawings will be described in detail for a preferred embodiment of the present invention. On the other hand, the city and the detailed description of the configuration and the action and effect thereof can be easily understood from those of ordinary knowledge in the art will be described briefly and in detail, or the center portions with respect to the present invention omitted.

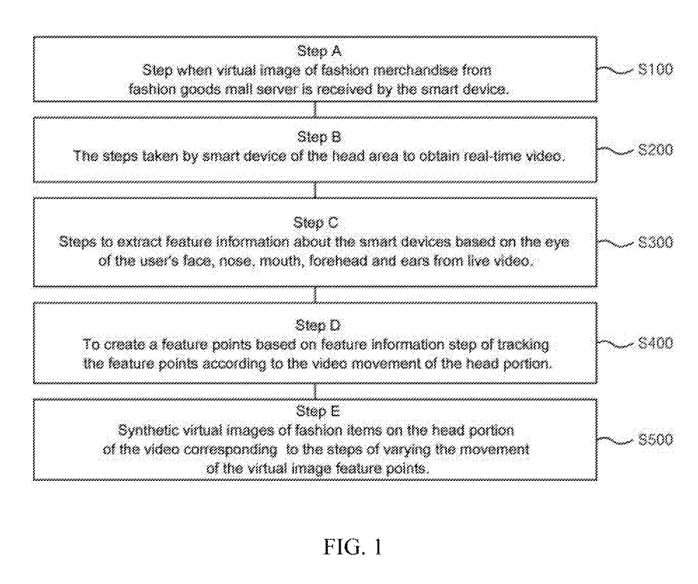

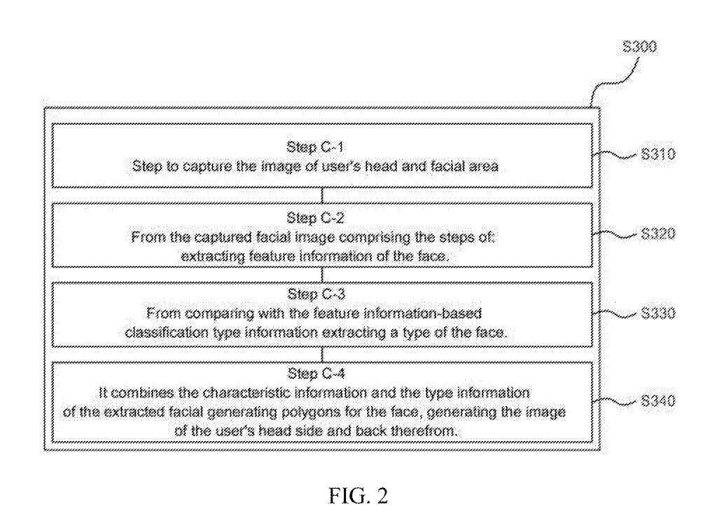

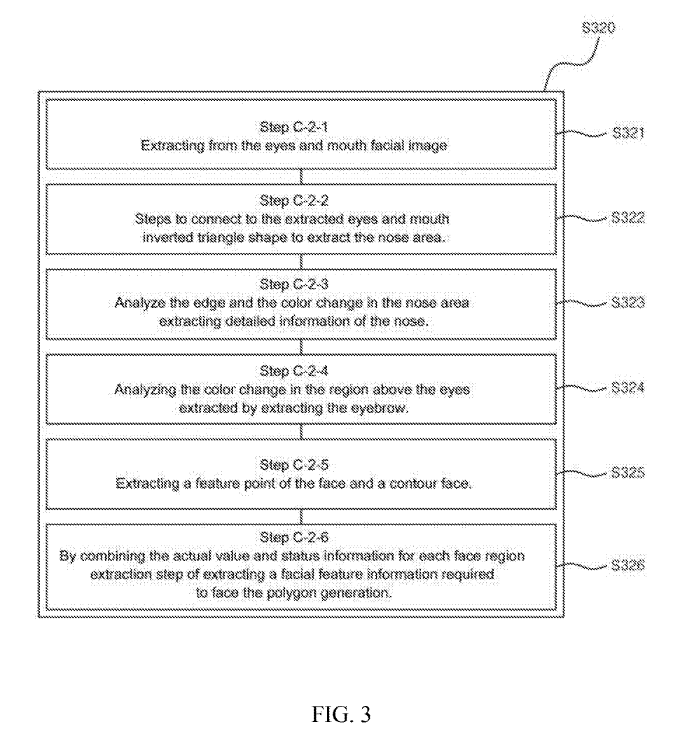

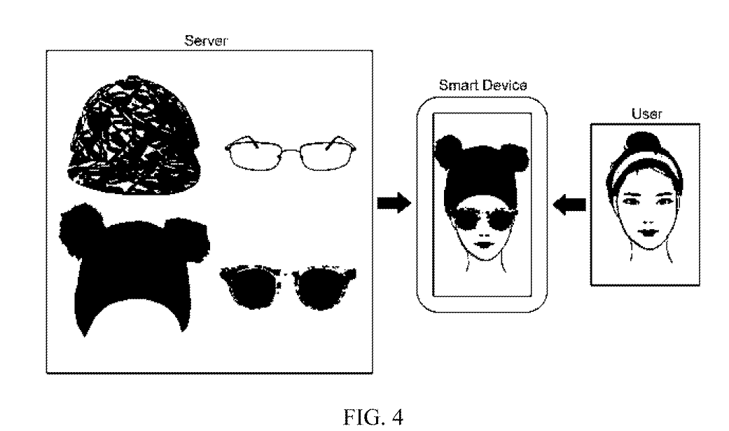

FIGS. 1 to 4 are diagrams for explaining the augmented reality image analysis method according to an embodiment of the present invention. Specifically, FIG. 1 is a block diagram showing the augmented reality image analysis method according to an embodiment of the present invention, FIG. 2 is a block diagram showing the details of step C according to the embodiment of the present invention, FIG. 3 is the is a block diagram showing the details of the step C-2 in accordance with an embodiment of the invention, FIG. 4 is a conceptual diagram showing the augmented reality analysis method according to an embodiment of the present invention.

As it is shown in FIG. 1, the augmented reality image analysis method for fashion items virtual wear according to the embodiment of the present invention, A method comprising: from a fashion item mole server user smart device receives a virtual image of a fashion product (S100) and smart devices to extract feature information about B comprising the steps taken for the head portion of the user obtain the video in real time (S200), and the nose by the eye of the user's face is a smart device from a real-time video, mouth, forehead, ears, create the feature points based on phase C (S300) and feature information by combining the virtual image of the fashion items in the head region of the D step of tracking feature points (S400), and the video according to the head area the movement of the videos E comprises a step (S500) for varying to a virtual image corresponding to a motion of the feature point.

Here, C step (S300) is a C-2 and extracting the feature information of the face from the illustrated described above, Step C-1 for capturing a facial image of the user's head area (S310), a captured facial image in FIG. 2 (S320) and, based on the characteristic information compared to the classified type by combining C-3 phase to extract the type information of the face (S330), and the extracted face characteristic information and type information to generate the polygons on the face, and this is from the C-4 can include step (S340) of generating an image side and back of the user's head.

Specifically referring to step C (S300), the user smart device to obtain a user's facial image face. This operates the camera in accordance with user input signals generated through the smart device input can be made by the user as the photographed face image of the face. Again, this can be achieved by loading the user's face as the face image stored in the storage unit is the smart devices, depending on the input signal.

Thus, when the user face image of the face is obtained, the smart device extracts the feature information of the face from the face image faces the acquired through a face recognition module of the control unit. The feature information of the face as referring to each part of the face from the user's facial image (eyes, nose, mouth, eyebrows, contour, forehead, chin etc.) specific characteristics, for example, the entire length and width, chin-length face and bottom of the face, middle of the face, including the information needed for the polygon generation for the height, nose length, mouth height, length, and the user's face, such as the height of the forehead, the eyes of the mouth of the nose.

In addition, C-2 step (S320) is connected to the nose region as snow-C and 2-1 reverse phase (S321) and, extracted eyes and mouth from the mouth triangle shape extracting facial face image shown in FIG. 3 C-2-2 extracting (S322) and, with the edge and 2-3 C-step analysis by the color change to extract the details of the nose (S323) in the nose area, the color of the extracted area in the snow C-2-4 comprising the steps of analyzing the variation extracted eyebrow (S324) and, C-2-5 extracting a feature point of the face and a contour face (S325), and the extracted measured values and statistics for each facial region It may combine the information contained in the C-2-6 step (S326) of extracting a user's facial face feature information required to generate the polygons.

Here, the eye is first extract the pupil can be made in the form of extracting the shape of the eye relative to the pupil, the extraction of these eyes and mouth can be accomplished using the general facial recognition technology.

As shown in FIG. 4 is now, smart devices according to the described process to date is informed of the information of the head portion, including the user's face through the video recording, user fashion a virtual image information of a variety of accessory items mole you want to buy and then transmitted from the server, and by collecting all information sent to the user and which protrudes to the image easy to confirm the image. Accordingly, it may represent a natural on their face images taken with the camera, as shown in the mirror the appearance of wearing a virtual fashion items there is an effect that can greatly improve the reliability and consumer satisfaction.

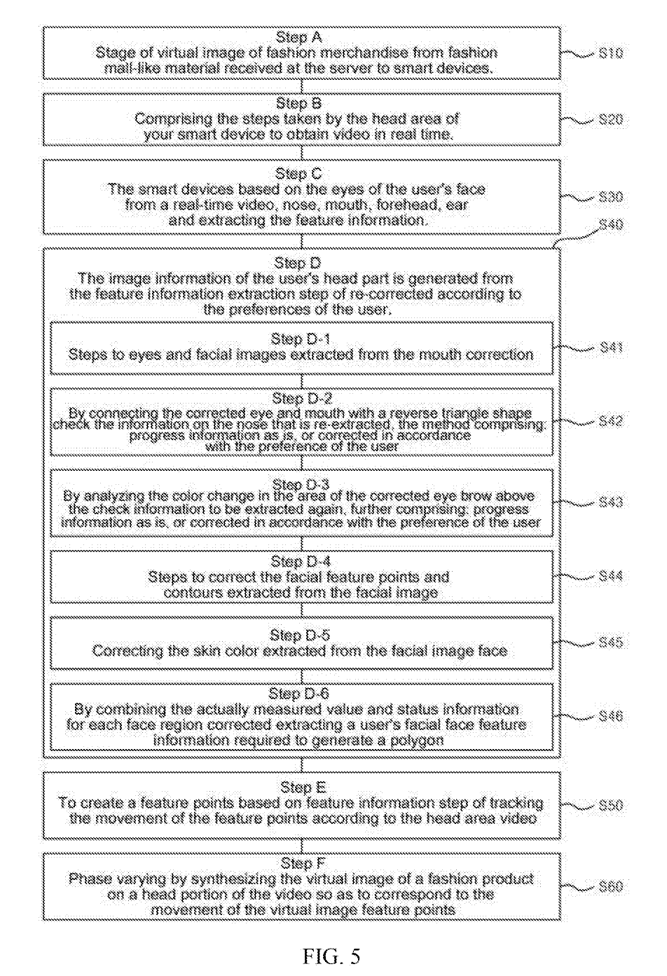

In addition to the case such as the above-described process, and according to another embodiment of the present invention, A step comprising: from a fashion item mole server user smart device receives a virtual image of a fashion product (S10) as shown in FIG. 5, the foregoing the device is to extract feature information about the B stage (S20) to shoot the head portion of the user obtain the video in real time, the nose by the eye of is the smart device the user's face from a real-time video, mouth, forehead, ears, and C phase (S30), and the D stage to re-extraction by correcting for your hair user preferences for video information of a portion (S40) which is generated from the feature information, generates a characteristic point a correction to the rough based on the feature information the variable is the E step (S50) to track the feature point according to the head area the movement of the moving image, and the virtual image by synthesizing the virtual image of the fashion product on a head portion of the video so as to correspond to the movement of the feature point which may be made, including the step F (S60).

The other embodiment example differs from the one embodiment described above of the invention after the extraction of the feature information for the user's face, without creating a feature point according to the right feature information, according to the user's characteristic information to match the preference of the user D is that the more capable step (S40) for correcting or editing the 3D face image. D stage through the fashion items without having to experience the bother of changing Visage, etc. according to the user's body weight, skin color, make-up and molding will be able to confirm whether or not you can go with your own. For example, in the case of women, it is to try synthesis of fashion products according to their skin color that can darken over tanning can learn in advance the fashion items for changes in the makeup, men's outdoor activities or tanning.

To this end, to determine the D-1 step (S41) are extracted from the facial image snow and correction mouth, information of the nose by connecting the corrected eye and mouth with a reverse triangle shape is extracted again, and the information as it proceeds, or D-2 step (S42) for correcting according to the preferences of the user, wherein in the compensation area of the snow by analyzing the color change to determine the eyebrow information to be extracted again, as it proceeds, or the user of the information step D-3 is corrected in accordance with the symbols (S43) and, with the face feature point and a contour D-4 step (S44) for correcting the extracted from the image, D-5 for correcting the skin color extracted from the facial face image step (S45) and; Characterized in that by combining the actually measured value and status information for each face region the corrected containing D-6 (S26) extracting a user's facial face feature information required to generate the polygons.

The features and technical advantages of the present invention to better understand the claims of the invention described below the foregoing was rather broadly described above. One of ordinary skill in the art will appreciate that the present invention without changing the departing from the scope and spirit may be embodied in other specific forms. Thus, embodiments described above are illustrative and in every way should be understood as non-limiting. The scope of the invention should be construed to be represented by the claims below rather than the foregoing description, and all such modifications that are derived from the form of the claims and their equivalents within the scope of the invention concept.

What is claimed is:

1. An image analysis method for virtual wear fashion items worn on the head portion of a person such as hats, earrings, and glasses in augmented reality, comprising steps of:
Step A. receiving a virtual image of fashion products from fashion items to your smart device mall server;
Step B, is a smart device that can shoot the head portion of the user obtain the video in real time;
Step C, extracting feature information about the smart devices in the nose, mouth, forehead, ears, by the eye of the user's face from a real-time video;
Step D, generating the characteristic point based on the feature information for tracking the feature points in accordance with the movement of the head part video; and
Step E, synthesizing the virtual image of the product to fashion the head portions of the virtual image of the video is variable so as to correspond to the movement of the feature point.

2. The method according to claim 1, wherein the Step C further comprises the step of:
Step C-1, capturing a face image in the user's head portion;
Step C-2, extracting the feature information of the face from the captured facial image; and
Step C-3, comparing to the feature information and the group classification type to extract the type information of the face,
wherein for fashion items virtual wearing, characterized in that to combine the extracted facial feature information and type information to generate the polygons on the face containing the Step C-4 to produce a side and back images of the user's head from which augmented reality, image analysis methods.

3. The method according to claim 2, wherein the step C2 further comprises the step of:
Step C-2-1, extracting from the mouth and eyes facial image;
Step C-2-2, linking the extracted mouth and eyes inverted triangle shape to extract the nose area;
Step C-2-3, analyzing the edge and the color change in the nose area extracting detailed information of the nose;
Step C-2-4, analyzing the color change in the extracted eyebrow area on the extracted eyes; and
Step C-2-5, extracting the facial feature points and a contour of the face,
wherein enhancement for the wearing virtual fashion goods characterized in that it comprises step C-2-6 comprising the steps of combining the measured values and statistics for each facial area of the extracted extracts the user's facial face feature information required to generate a polygon reality image analysis methods.

4. An image analysis methods for virtual wear fashion items worn on the head portion of a person such as hats, earrings, and glasses in augmented reality, comprising steps of:
Step A, receiving a virtual image of fashion products from fashion items to your smart device mall server;
Step B, smart device that can shoot the head portion of the user obtain the video in real time;
Step C, extracting feature information about the smart devices in the nose, mouth, forehead, ears, by the eye of the user's face from a real-time video;
Step D, the image information of the user's head portion that is generated from the feature information extracted by re-calibrated to the preference of the user; and
Step E, generating a feature point as a rough correction based on the feature information to the step of tracking feature points in accordance with the movement of the head part video; and
Step F, by the step of the head portion of the video synthesizing a virtual image of said variable fashion items that the virtual image to correspond to the movement of the feature point.

5. The method according to claim 4, wherein Step D further comprises:
Step D-1, to the face and eyes, mouth correction extracted from the face image;
Step D2, checking the information on the connection mouth and nose to the corrected eye to the triangle shape that is re-extracted, and directly proceeds to step D-2, or the correction information according to the preferences of the user;
Step 3, determining the information to be extracted eyebrow again analyzes the color change in the area above the corrected eye, and directly proceeds to Step D-3, or the correction information according to the preferences of the user;
Step D-4, correcting the facial contours and feature points extracted from the face image,
Step D-5, correcting the skin color to the face extracted from the face image, and;
Step D-6, extracting a user's facial face feature information required for polygon generation analysis method.
